(19) United States
(12) Patent Application Publication
(10) Pub. No.: US 2007/0172690 A1
(43) Pub. Date: Jul. 26, 2007

(54) Joining method, method of mounting semiconductor package using the same, and substrate-joining structure prepared by the joining method

(75) Inventors: Si-suk Kim, Cheonan-si (KR); Kwang-su Yu, Cheonan-si (KR); Dong-chun Lee, Cheonan-si (KR); Jae-hoon Choi, Dujeong-dong (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 11/399,499

(22) Filed: Apr. 7, 2006

(30) Foreign Application Priority Data
Jan. 24, 2006 (KR) 10-2006-0007267

(51) Int. Cl. B32B 15/01

(52) U.S. Cl. 428/646; 148/528

(57) ABSTRACT

A joining method, a method of mounting a semiconductor package (PKG) using the same, and a substrate-joining structure prepared thereby are provided. The joining method may comprise placing a first junction composition including tin and silver, and a second junction composition, including tin and bismuth to contact each other and forming a junction by performing a thermal treatment on the junction compositions at a temperature of at least 170° C. or higher.

### PRIORITY STATEMENT

This application claims the benefit of Korean Patent Application No. 10-2006-0007267, filed on Jan. 24, 2006, in the Korean Intellectual Property Office, the disclosure of which is incorporated herein in its entirety by reference.

### BACKGROUND

1. Field of the Invention

Example embodiments of the present invention relate to a method of joining a package and the like with a substrate at a low temperature.

2. Description of the Related Art

To join elements or bodies, conventional bonding methods may apply heat to a metal composition. For example, there are known soldering methods for joining elements or bodies by melting a third material having a melting point lower than that of the elements or bodies to be joined. The third material may be a solder.

Conventionally, an alloy containing lead (Pb) has been used as solder. Because lead has a property of melting (and hence, joining) at a relatively low temperature, lead has been commonly used for joining heat-sensitive electronic components.

Research has been conducted with respect to a substrate bonding method using a lead-free solder. Conventional lead-free solders may include a tin (Sn)-silver (Ag) solder and a tin (Sn)-bismuth (Bi) solder.

Because tin (Sn)-silver (Ag) solder has a higher junction temperature, it may be difficult to use for temperature-sensitive electronic components. For example, a solder containing tin, silver and copper (Cu) may be melted at a temperature of about 217° C., and may be joined at a temperature of about 250° C. to 260° C., which is a relatively high junction temperature. Thus, the elements or bodies to be joined, for example, substrates may be bent and/or substrates are lifted, thereby causing bad junction, for example, a nonwet junction, described in more detail below.

FIG. 1 is a photograph illustrating a substrate-joining structure formed by mounting a semiconductor package on a printed circuit board using a conventional joining method.

Referring to FIG. 1, a solder ball containing tin, silver and copper is formed on a semiconductor package (PKG), and a solder paste containing tin, silver and copper is formed on a printed circuit board (PCB). The solder ball and the solder paste may be reflowed at a temperature of about 250° C. to join the PKG to the PCB. In this conventional bonding method, the solder ball and the solder paste are formed of the same composition containing tin, silver and copper, respectively, and reflow at a relatively high temperature of 250° C. through 260° C. As a result, there is a problem in that the temperature-sensitive PKG may be bent. Such a problem may negatively influence the reliability of electronic components sensitive to temperature.

FIG. 2 is a photograph illustrating a junction of the substrate-joining structure of FIG. 1.

Referring to FIG. 2, it can be seen that a solder ball 3 formed on the PKG is joined with solder paste 2 formed on the PCB in a substrate-joining structure. As illustrated in FIG. 1, because the junction is performed at a relatively high temperature, the PKG may be bent, thereby causing warpage. Also, because the solder ball 3 joined to the PCB does not come into contact with the solder paste 2, a nonwet phenomenon (shown by the “X” in FIG. 2) occurs.

A tin-bismuth solder may be joined at a relatively low temperature because the melting temperature of bismuth is lower. However, there may be a defect in that bismuth grains coarsen after melting. Because the bismuth grains coarsen and does not disperse evenly over the whole junction or connection, cracks occur along the coarsened surface and in a worst case, the solder junction may be broken.

FIG. 3 is a photograph illustrating a junction of a substrate-joining structure using a conventional bonding method.

Referring to FIG. 3, in the case of a solder using 43% by weight of tin and 57% by weight of bismuth, a reflow process is performed at a relatively low temperature of 139° C., but a crack Y is visible due to the coarsening of bismuth.

To solve the aforementioned problems of the tin-silver solder or tin-bismuth solder, the conventional art discloses a lead-free solder containing tin, silver, bismuth and copper. However, in the conventional art, the solders formed on the substrate to be joined, that is, on the PKG and the PCB, include all of the above-described four elements. When a solder includes as many as elements as set forth above, it is difficult to control the reflow temperature to safely and/or effectively join the substrate because each element has a different melting temperature.

### SUMMARY

Example embodiments of the present invention provide a joining method for joining two elements or bodies, for example a substrate and a package, at a lower temperature and/or with an improved junction.

Example embodiments of the present invention also provide a method of mounting a semiconductor package (PKG) on a printed circuit board (PCB) using example joining method.

Example embodiments of the present invention also provide a substrate-joining structure, in which a plurality of substrates are connected more reliably.

Example embodiments of the present invention also provide a joining method at lower temperature.

According to an example embodiment of the present invention, there is provided a joining method comprising: preparing a first junction composition including tin (Sn) and silver (Ag); and preparing a second junction composition including tin (Sn) and bismuth (Bi). By contacting the first junction composition and the second junction composition, a thermal treatment is performed at a temperature of at least 170° C. or higher, thereby forming a junction having the first junction composition and the second junction composition in contact with each other.

In an example embodiment, the first junction composition may include 95 to 98% by weight of tin and 2 to 5% by weight of silver with respect to the weight of the first junction composition.

In an example embodiment, the first junction composition may comprise at least one metal selected from the group consisting of copper (Cu), indium (In) and bismuth (Bi). When the first junction composition further comprises the metal, the first junction composition comprises, for example, 95 to 98% by weight of tin, 3 to 4% by weight of silver, and 0.1 to 1% by weight of the metal with respect to the weight of the first junction composition. In an example embodiment, when the metal is copper, the first junction composition may comprise about 96.5% by weight of tin, about 3% by weight of silver, and about 0.5% by weight of copper with respect to the weight of the first junction composition.

In an example embodiment, the second junction composition may comprise 30 to 90% by weight of tin, and 10 to 60% by weight of bismuth with respect to the weight of the second junction composition.

In addition, the second junction composition may further comprise silver, and the second junction composition comprises, for example, 30 to 89.9% by weight of tin, 10 to 60% by weight of bismuth, and 0.1 to 10% by weight of silver with respect to the weight of the second junction composition.

In an example embodiment, the first junction composition may have the composition ratio as above, and may be formed as a solder bump, for example, a solder ball. The second junction composition in contact with the first junction composition may be formed as a solder paste, a solder plating layer, and the like. The solder paste may be formed using a screen printing method, and the solder plating layer may be formed using a plating method.

A joining method in accordance with example embodiments of the present invention may comprise contacting junction compositions having different composition materials and performing a thermal treatment at a temperature of at least 170° C. or higher, for example, 190 to 200° C. By performing the thermal treatment at a temperature of at least 170° C. or higher, the second junction composition is melted, and the melted second junction composition is diffused to the first junction composition, thereby forming the junction. As the temperature is increased, for example, if the thermal treatment is performed 190 to 200° C. or higher, the second junction composition may be further diffused to the first junction composition, thereby forming a stronger junction at a lower temperature. That is, because the coarsening of bismuth is reduced or prevented, and the joining is possible at a low temperature of 190 to 200° C., a higher reliability of the substrate-joining structure may be realized. Useful temperatures of the thermal treatment may be determined in various values by those in this art depending on the contents of the junction compositions, the weight ratios of the first junction composition and the second junction composition, and the like.

In an example embodiment, the thermal treatment may be performed using a reflow oven.

In an example embodiment, the junction formed through the thermal treatment may have an n-layer structure (where n≧2) composed of at least an upper layer including tin and silver and a lower layer including tin, silver, and bismuth. A volume ratio of the upper layer and the lower layer may be determined by the temperature of the thermal treatment. For example, as the temperature of the thermal treatment is increased, the second junction composition may be further diffused to the first junction composition, and thus, the volume ratio of the lower layer is increased.

After determining the volume ratio of the upper and lower layers of the junction, the temperature of the thermal treatment may be determined. A desired junction defined in terms of strength, weight, and/or electrical connection of the substrate, for example, defined in terms of the volume of the lower layer of the junction may be determined, and the temperature of the thermal treatment may be controlled according thereto.

When the first junction composition further comprises metals selected from copper (Cu), indium (In), and bismuth (Bi), the junction may have an n-layer structure comprising at least an upper layer including tin, silver, and the metal, and a lower layer including tin, silver, bismuth, and the metal.

Because a joining method in accordance with example embodiments of the present invention may be performed at a lower temperature, they may be employed when a temperature-sensitive electronic component is mounted on a printed circuit board (PCB). For example, they may be used for the semiconductor package manufacture of a surface mounting type (SMT), for example, die bonding, wire bonding, flip-chip bonding, and the like.

Example embodiments of the present invention also provide a method of mounting a semiconductor package (PKG).

The method of mounting the PKG may comprise forming a first junction composition including tin (Sn) and silver (Ag) on an element, body or package. A second junction composition including tin (Sn) and bismuth (Bi) may be formed on an element, body or PCB. The first junction composition may be placed to contact the second junction composition, and a thermal treatment may be performed at a temperature of at least 170° C., thereby forming a junction by contacting the first junction composition and the second junction composition with each other.

The first junction composition formed (for example, on the package) may comprise about 96.5% by weight of tin, about 3% by weight of silver, and about 0.5% by weight of copper (Cu) with respect to the weight of the first junction composition. Further, the second junction composition formed (for example, on the PCB) may comprise about 42% by weight of tin, about 57% by weight of bismuth, and about 1% by weight of silver with respect to the weight of the second junction composition.

The thermal treatment may be performed using a reflow oven at a temperature of at least 170° C. or higher, and for example, may be performed at a temperature of 190 to 200° C. for a lower temperature junction of higher reliability.

Further, the thermal treatment may be selectively applied only on the PCB having the first junction composition formed therein with the heat at a temperature of at least 170° C. or higher, for example, in a range of 190 to 200° C. Thus, a semiconductor chip embedded in the PKG may be safely protected. For example, by using the mounting method of the PKG as above, reliability may be increased in the case of a temperature-sensitive semiconductor chip.

The junction may comprise an upper layer including tin, silver, and copper, and a lower layer including tin, silver, bismuth, and copper.

The first junction composition may be formed as a lead frame of the PKG, a solder ball of a BGA PKG, and the like. The second junction composition may be formed as a solder paste of the PCB, a solder plating layer, and the like. Therefore, by using the mounting method of the PKG, the solder ball formed in the PKG and the solder paste formed in the PCB may be joined.

Also, example embodiments of the present invention provide a substrate-joining structure comprising at least two substrates, and a junction connecting the substrates.

The junction may have an n-layer structure composed of at least an upper layer including tin and silver, and a lower layer including tin and bismuth. The lower layer may further include silver.

Further, the junction may have an n-layer structure composed of at least an upper layer including tin and silver, and a metal selected from copper, indium, and bismuth, and a lower layer including tin, silver, bismuth, and the metal. The metal may be copper.

The lower layer of the junction may have an area ratio of about 1 to 99% with respect to the entire area of the junction.

Bismuth contained in the lower layer may be 50% by weight or less with respect to the total weight of the lower layer. This is because bismuth may coarsen and a crack may occur in the junction if the weight ratio is higher than that. Silver contained in the lower layer may be 5% by weight or less with respect to the total weight of the lower layer.

The substrates may be a semiconductor chip, a PKG having the semiconductor chip mounted thereon, and the like. Further, other substrates to be electrically connected to the substrate may be a PCB where a semiconductor chip maybe mounted; a PCB where a chip support pad such as a tape and a flexible substrate, or a PKG may be mounted; and the like.

Therefore, by providing a joining method capable of being performed at a lower temperature according to example embodiments of the present invention, junction failure caused due to a bent substrate may be reduced or prevented, and cracks caused due to coarsened bismuth may be reduced or suppressed.

Further, by employing a joining method according to example embodiments of the present invention, a PKG can be safely mounted in a PCB.

Furthermore, a plurality of substrates may be joined using a junction having an n-layer structure composed of at least upper and lower layers by employing the joining method. Therefore, example embodiments of the present invention provide a substrate-joining structure, in which substrates may be joined safely and effectively by the junction of the n-layer structure.

### BRIEF DESCRIPTION OF THE DRAWINGS

The above and other features and advantages of the present invention will become more apparent by describing in detail example embodiments thereof with reference to the attached drawings in which:

FIG. 1 is a photograph illustrating a substrate-joining structure, in which a semiconductor package is mounted on a printed circuit board using a conventional joining method;

FIG. 2 is a photograph illustrating a junction of the substrate-joining structure of FIG. 1;

FIG. 3 is a photograph illustrating a junction of a substrate-joining structure using a conventional bonding method;

FIGS. 4 through 6 are sectional views illustrating a joining method according to an example embodiment of the present invention; and

FIG. 7 is a sectional view illustrating a substrate-joining structure, in which a PKG is mounted in a PCB using a joining method in accordance with an example embodiment of the present invention.

FIG. 8 is a sectional view illustrating a substrate-joining structure, in which a PKG is mounted in a PCB using a joining method in accordance with another example embodiment of the present invention.

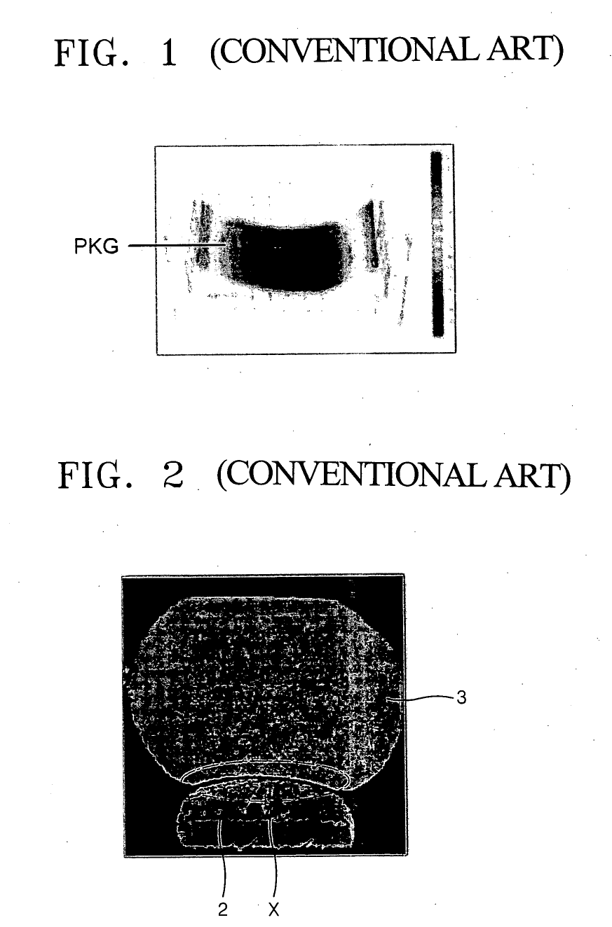

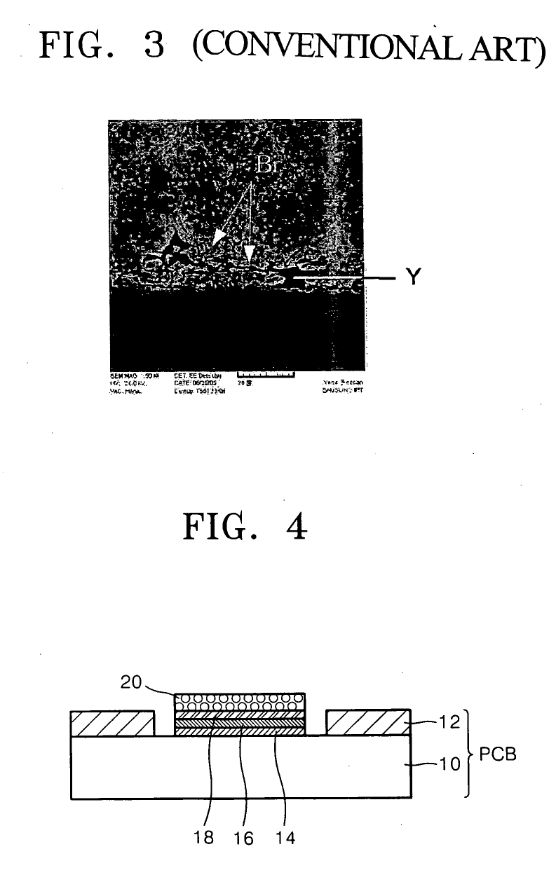

### DETAILED DESCRIPTION OF EXAMPLE EMBODIMENTS OF THE INVENTION

Various example embodiments of the present invention will now be described more fully with reference to the accompanying drawings in which some example embodiments of the invention are shown. In the drawings, the thicknesses of layers and regions are exaggerated for clarity.

Detailed illustrative embodiments of the present invention are disclosed herein. However, specific structural and functional details disclosed herein are merely representative for purposes of describing example embodiments of the present invention. This invention may, however, may be embodied in many alternate forms and should not be construed as limited to only the embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the invention to the particular forms disclosed, but on the contrary, example embodiments of the invention are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or” includes any and all combinations of one or more of the associated listed items.

It will be understood that when an element or layer is referred to as being “formed on” another element or layer, it can be directly or indirectly formed on the other element or layer. That is, for example, intervening elements or layers may be present. In contrast, when an element or layer is referred to as being “directly formed on” to another element, there are no intervening elements or layers present. Other words used to describe the relationship between elements or layers should be interpreted in a like fashion (e.g., “between” versus “directly between”, “adjacent” versus “directly adjacent”, etc.).

The terminology used herein is for the purpose of describing particular embodiments only and is not intended to be limiting of example embodiments of the invention. As used herein, the singular forms “a”, “an” and “the” are intended to include the plural forms as well, unless the context clearly indicates otherwise. It will be further understood that the terms “comprises”, “comprising,” “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the FIGS. For example, two FIGS. shown in succession may in fact be executed substantially concurrently or may sometimes be executed in the reverse order, depending upon the functionality/acts involved.

The present invention will now be described more fully hereinafter with reference to the accompanying drawings, in which example embodiments of the invention are shown. This invention may, however, be embodied in many different forms and should not be construed as being limited to the example embodiments set forth herein. Rather, these example embodiments are provided so that this disclosure will be thorough and complete, and will fully convey the scope of the invention to those skilled in the art. In the drawings, the thicknesses of layers and regions are exaggerated for clarity.

FIGS. 4 through 6 are sectional views illustrating a joining method according to an example embodiment of the present invention. Referring to FIG. 4, a PCB is provided. The PCB may be prepared by forming a solder resist 12 as an insulating material on a substrate body 10. The substrate body 10 may use an insulating material, for example, FR4 or BT resin. The solder resist 12 may have an opening where a junction will be formed. A copper layer 14 may be formed on the substrate body 10 exposed by the opening. The surface of the copper layer 14 may be treated with nickel and/or gold, and thus, a nickel layer 16 and/or a gold layer 18 may be sequentially formed thereon. A solder paste 20 may be formed on the gold layer 18 using a screen printing method. Alternatively, a solder plating layer may be formed using a plating method.

The solder paste 20 may include tin and bismuth. In an example embodiment, the solder paste 20 may include 30 to 90% by weight of tin and 10 to 60% by weight of bismuth with respect to the weight of the solder paste 20. In addition, the solder paste may further include silver, and in an example embodiment, the solder paste 20 may include 30 to 89.9% by weight of tin, 10 to 60% by weight of bismuth, and 0.1 to 10% by weight of silver.

The PCB may employ any type that a PKG can be mounted thereon, and may be modified in various forms and materials, for example, a planar structure, by those in this art.

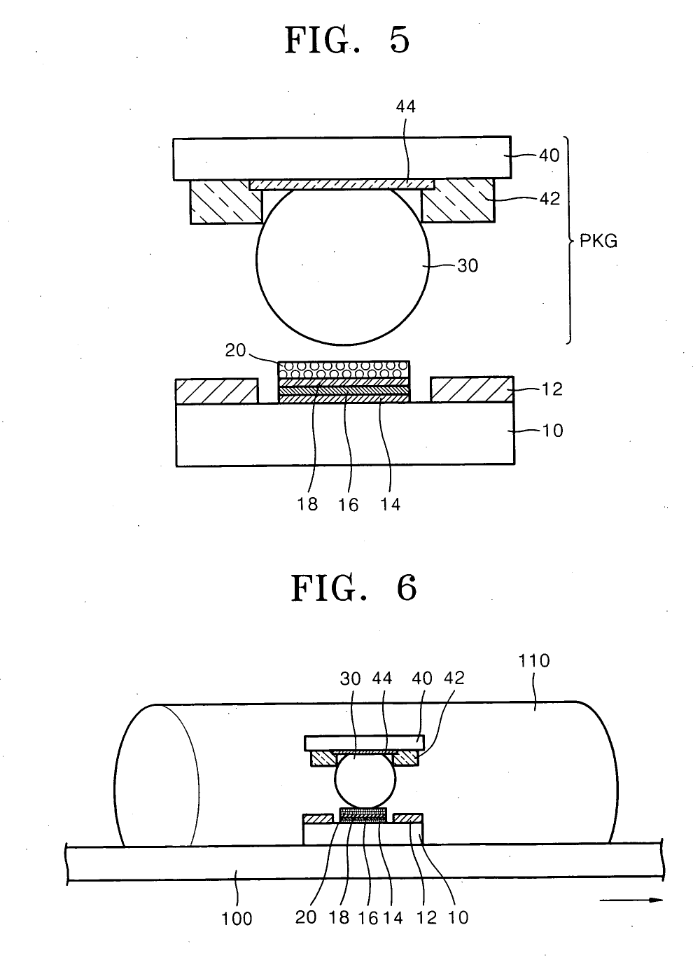

Referring to FIG. 5, a PKG having a semiconductor chip mounted on a chip support paddle may be provided. The semiconductor chip may include a memory circuit, for example, DRAM, SRAM, and the like. The PKG may use a surface-mounting type package, for example, a BGA package, a flip chip package, and the like.

For example, the PKG may include a BGA PKG 40, in which a semiconductor chip is die-connected to an epoxy substrate. A plated copper conductive layer and a die pad may be formed at one side of the epoxy substrate. The semiconductor chip may be connected to the die pad. The copper conductive layer and the semiconductor chip may be electrically connected using a gold wire. The semiconductor chip and the gold wire may be protected from an exterior stimulus by molding them using an insulating material. A via for ground and signal may be formed inside the epoxy substrate. A mask layer 42, which may be composed of an insulating material, may be formed on the back surface of the epoxy substrate. An opening may be formed in the mask layer 42, and a metal pad 44 may be formed on the back surface of the epoxy substrate exposed by the opening. The metal pad 44 may include a copper layer, a nickel layer, and/or a gold layer, which are sequentially stacked. A solder ball 30 may be placed on the metal pad 44.

The solder ball 30 may include tin and silver. The solder ball 30 may include 95 to 98% by weight of tin and 2 to 5% by weight of silver with respect to the weight of the solder ball 30.

Further, the solder ball 30 may further include at least one metal selected from the group consisting of copper, indium and bismuth. In an example embodiment, the solder ball 30 may include 95 to 98% by weight of tin, 3 to 4% by weight of silver, and 0.1 to 1% by weight of the at least one metal with respect to the weight of the solder ball 30. For example, when the at least one metal is copper, the solder ball 30 may include about 96.5% by weight of tin, about 3% by weight of silver, and about 0.5% by weight of copper.

Example embodiments of a PKG have a solder ball 30 formed therein, but the present invention is not limited thereto. For example, other types of PKGs having various solder bumps, studs, or posts, for example, a planar shape, in addition to the ball shape, may be used.

The PKG may be placed to contact the PCB and the solder ball 30 and the solder paste 20 are placed in contact with each other.

Referring to FIG. 6, the contacting resultant structure may be thermally treated, for example, using a reflow oven at a temperature of at least 170° C. or higher. For example, the resultant structure may be placed on a conveyor belt 100, and the conveyor belt 100 may be made to move such that the resultant structure passes through a reflow oven 110. When heat is applied by infrared rays of the reflow oven 110, a junction is formed to electrically connect the PKG and the PCB.

The thermal treatment may be performed at a temperature of at least 170° C. or higher, for example, in a range of 190 to 200° C. The solder paste 20 may be melted at a temperature of about 170° C. or higher, and diffused into the solder ball 30 so as to form the junction. As the temperature is increased, the solder paste 20 may be further diffused into the solder ball 30, for example, at a temperature of about 190° C. or higher so as to form a junction, which is stronger when joined at a lower temperature. That is, the coarsening of bismuth may be reduced or prevented, and the junction may be realized at a lower temperature of 190 to 200° C., thereby realizing more reliable substrate-joining structures.

In an example embodiment, a thermal treatment process may performed on the entire resultant structure, in which the solder paste 20 and the solder ball 30 are joined, using an oven for the thermal treatment, or only the PCB having the solder paste 20 formed therein may be selectively applied with the heat at a temperature of at least 170° C. or higher, for example, in a range of 190 to 200° C. Thus, a semiconductor chip embedded in the PKG may be protected. For example, the use of the mounting method of the PKG as above may increase the reliability of a temperature-sensitive semiconductor chip.

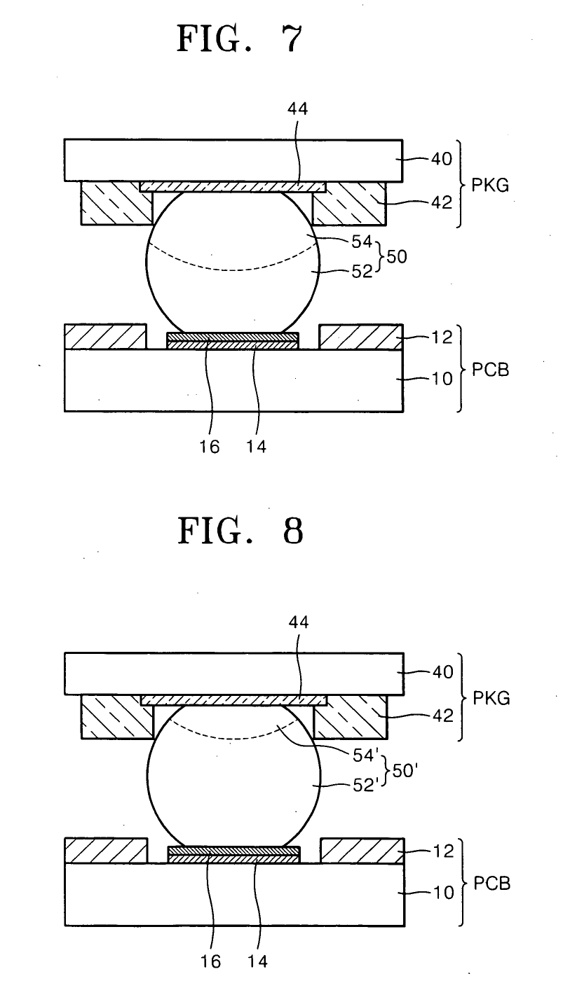

FIG. 7 is a sectional view illustrating a substrate-joining structure, in which a PKG is mounted in a PCB using a joining method in accordance with an example embodiment of the present invention. FIG. 7 illustrates a substrate-joining structure in accordance with an example embodiment of the present invention, in which a PKG is mounted in a PCB by thermally treating at a temperature of about 170° C.

Referring to FIG. 7, a substrate-joining structure in accordance with an example embodiment of the present invention may include a PCB having a solder resist 12, a copper layer 14, and a nickel layer 16 formed on a substrate body 10; and a PKG having a mask layer 42 and a metal pad 44 formed on the back surface of an epoxy substrate. A semiconductor chip may be die-connected to a surface of the epoxy substrate. Further, the substrate-joining structure may include a junction 50 electrically connecting the PCB and the PKG.

The PCB may include a metal layer (for example, the metal layer 18 of FIG. 5) before the thermal treatment, but the metal layer 18 may have a thickness of 1 μm or less, and may be diffused to the junction 50 during the thermal treatment. Thus, the metal layer is not illustrated in FIG. 7.

Referring to FIG. 7, after the thermal treatment at a temperature of about 170° C., the solder paste 20 (FIG. 5) may be melted and diffused into the solder ball 30 (FIG. 5), thereby forming the junction 50 having a double-layer structure composed of upper and lower layers with different compositions.

For example, the junction 50 may be composed of an upper layer 54, including tin and silver, and a lower layer 52, including bismuth.

Further, the upper layer 54 of the junction 50 may include tin and silver and a metal selected from copper, indium, and bismuth, and the lower layer 52 thereof may include tin, silver, bismuth, and at least one metal. The metal may be copper.

When the solder ball 30 and the solder paste 20 of FIG. 5 are joined at a temperature of about 170° C., the junction 50 may be formed such that the lower layer 52 has an area ratio of about 10 to 20% with respect to the entire area of the junction 50. The solder ball 30 may include tin, silver, and copper, and its volume ratio may be 86%, and the solder paste 20 may include tin, bismuth, and silver, and its volume ratio may be 14%.

In order to increase the area of the lower layer 52 of FIG. 7, the temperature of the thermal treatment may be increased to 170° C. or higher. This is because the solder paste may be melted and further diffused into the solder ball if the temperature of the thermal treatment is increased so as to increase the area of the lower layer. FIG. 8 is a sectional view illustrating a substrate-joining structure, in which a PKG is mounted in a PCB, where the junction 50′ may be composed of an upper layer 54′ and a lower layer 52′, where the area of the lower layer 52′ compared to the area of the upper layer 54′ is greater than the area of the lower layer 52 compared to the area of the upper layer 54.

As described above, according to example embodiments of the present invention, joining of elements or bodies may be performed at a lower temperature employing junction compositions including different composition ratios of materials, thereby providing improved reliability of junction characteristics. Warpage of a substrate to be joined may be reduced or prevented, and thus, junction failure related thereto may be reduced or prevented. For example, because a joining process is performed at a lower temperature, the damage of a temperature-sensitive electronic component, for example, a PKG having an embedded semiconductor chip, may be reduce or prevented, thereby improving a reliability of the semiconductor chip.

Further, the PKG may be safely mounted on a PCB using the joining method of example embodiments of the present invention.

Furthermore, example embodiments of the present invention provide substrates, and a substrate-joining structure including a junction connecting the substrates. The junction may have a double-layer structure of an upper layer and a lower layer, and thus, the junction may connect the substrates safely and effectively. Therefore, reliability of the substrates may be improved.

Although example embodiments of the present invention disclose a double-layer junction structure, n-layered junction structures (where n>2) may also be considered within the scope of the present invention.

While the present invention has been particularly shown and described with reference to example embodiments thereof, it will be understood by those of ordinary skill in the art that various changes in form and details may be made therein without departing from the spirit and scope of the present invention as defined by the following claims.

What is claimed is:

1. A joining method comprising:
preparing a first junction composition including tin (Sn) and silver (Ag);
preparing a second junction composition including tin (Sn) and bismuth (Bi);
contacting the first junction composition and the second junction composition; and
performing a thermal treatment at a temperature of at least 170° C. or higher, thereby forming a junction having the first junction composition and the second junction composition in contact with each other.

2. The method of claim 1, wherein the first junction composition further comprises at least one metal selected from the group consisting of copper (Cu), indium (In) and bismuth (Bi).

3. The method of claim 2, wherein the first junction composition comprises 95 to 98% by weight of tin, 3 to 4% by weight of silver, and 0.1 to 1% by weight of the metal with respect to the weight of the first junction composition.

4. The method of claim 1, wherein the second junction composition further comprises silver (Ag).

5. The method of claim 1, wherein the second junction composition comprises 30 to 90% by weight of tin, and 10 to 60% by weight of bismuth with respect to the weight of the second junction composition.

6. The method of claim 4, wherein the second junction composition comprises 30 to 89.9% by weight of tin, 10 to 60% by weight of bismuth, and 0.1 to 10% by weight of silver with respect to the weight of the second junction composition.

7. The method of claim 1, wherein the thermal treatment is performed at a temperature of 190 to 200° C.

8. The method of claim 1, wherein the junction has a double-layer structure composed of an upper layer including tin and silver, and a lower layer including tin, silver, and bismuth.

9. The method of claim 2, wherein the junction has a double-layer structure composed of an upper layer including tin, silver and the at least one metal, and a lower layer including tin, silver, bismuth and the at least one metal.

10. A method of mounting a semiconductor package (PKG) comprising:
forming a first junction composition including tin (Sn) and silver (Ag) on a PKG;
forming a second junction composition including tin (Sn) and bismuth (Bi) on a printed circuit board (PCB);
placing the first junction composition to contact the second junction composition; and
performing a thermal treatment at a temperature of at least 170° C., thereby forming a junction by contacting the first junction composition and the second junction composition with each other, in which the junction comprises an upper layer including tin and silver, and a lower layer including tin, silver and bismuth.

11. The method of claim 10, wherein the first junction composition further comprises copper (Cu).

12. The method of claim 11, wherein the first junction composition comprises 96.5% by weight of tin, 3% by weight of silver, and 0.5% by weight of copper (Cu) with respect to the weight of the first junction composition.

13. The method of claim 10, wherein the second junction composition further comprises silver (Ag).

14. The method of claim 13, wherein the second junction composition comprises 42% by weight of tin, 57% by weight of bismuth, and 1% by weight of silver with respect to the weight of the second junction composition.

15. The method of claim 10, wherein the thermal treatment is performed at a temperature of 190 to 200° C.

16. The method of claim 10, wherein the thermal treatment is performed at a temperature of 190 to 200° C only on the PCB having the second junction composition formed thereon.

17. The method of claim 10, wherein the first junction composition is a solder bump.

18. The method of claim 10, wherein the second junction composition is a solder paste formed on the PCB using a screen printing method.

19. The method of claim 10, wherein the second junction composition is a solder plating layer formed on the PCB using a plating method.

20. A substrate-joining structure comprising:
at least two substrates; and
a junction connecting the substrates, in which the junction has an n-layered structure (where n≧2) composed of at least an upper layer including tin and silver, and a lower layer including tin, silver and bismuth.

21. The substrate-joining structure of claim 20, wherein the upper layer further comprises at least one metal selected from the group consisting of copper, indium, and bismuth.

22. The substrate-joining structure of claim 20, wherein the lower layer comprises 0 to 50% by weight of bismuth with respect to the weight of the lower layer.

23. The substrate-joining structure of claim 20, wherein the lower layer comprises 0 to 5% by weight of silver with respect to the weight of the lower layer.

24. The substrate-joining structure of claim 20, wherein the lower layer has an area ratio of about 1 to 99% with respect to the entire area of the junction.
